(19) United States
(12) Patent Application Publication
(10) Pub. No.: US 2015/0013171 A1
(43) Pub. Date: Jan. 15, 2015

(54) Multi-Function Utility Knife

(71) Applicant: Yuewei Wu, Ninghai (CN)

(72) Inventor: Yuewei Wu, Ninghai (CN)

(21) Appl. No.: 13/941,503

(22) Filed: Jul. 14, 2013

(51) Int. Cl. B26B 1/08

(52) U.S. Cl. CPC B26B 1/08
USPC 30/162

(57) ABSTRACT

A multi-function utility knife has a housing, a blade seat forward slidably received in the housing, a blade fixed to the blade seat, a driving unit having an actuator protruding out from the housing and an actuator seat reciprocally slidable along the housing, a blade seat return spring linking the blade seat and the housing, a blade change means, and a function switch. The blade of the multi-function utility knife is also able to be either multi-levelly locked when extended or automatically retractable.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a multi-function utility knife, and more particularly, to a utility knife having functions of multi-level positioning and automatic retractability.

2. Description of Related Art

Utility knife is a commonly used hand tool for cutting, e.g., wood, paper, leather, plastic panel, cord, and cardboard. Some retractable utility knives are developed for safer use A conventional retractable utility knife has a blade being able to be pulled into a shell by a spring when a user release an actuator after use. For more convenient use, some positioning utility knives are developed blades of which are able to be locked at a specified position after being extracted. However, one utility knife having one of above function is usually not able to satisfy all requirements in actual use because the situation of work is different. If a user needs the blade to be extended for a long time, constantly pushing of the actuator with his thumb in cutting may become a heavy burden. He may needs a function of blade positioning for this instance. And when cutting a thin work piece, the blade should be extended a short distance to avoid breaking. When cutting a thick work piece, the blade should be extended a long distance in order to cut the object through. When the user needs to cut a small quantity of relatively softer materials, he may wish that the blade become automatic retractable to increase safety. However, there is not such a utility knife until now in this art which is able to satisfy the users all above requirements.

### BRIEF SUMMARY OF THE INVENTION

The main object of the invention is to provide a multi-function utility knife a blade of which is able to be either multi-level positioned or auto-retractable when extended.

In order to accomplish above object, the invention provides a multi-function utility knife having:
a housing,
a blade seat slidably received in the housing and having a blade seat notch,
a blade fixed to the blade seat and having at least, one blade notch,
a driving unit having an actuator seat reciprocally slidable along the housing, an actuator being fixed to the actuator seat and protruding out from the housing, a pole securely formed on the actuator seat, a restore spring provided between the pole and the blade seat, and a protrusion being formed on the actuator seat and facing outward from the housing,
a blade seat return spring having one end being fixed to the blade seat and the other end being fixed to an inner surface of the housing,
a blade change means having a button, a resilient element biasing the button against the housing, and a spring bar having one end being fixed to the blade seat and a free end having a side protruding pressing finger and a blade installing finger, and,
a function switch having a switching button, a rack contained in the housing, a spring plate having at least one spring foot, and two positioning slots in the inner surface of the housing for receiving the spring foot of the spring plate, the switching button, the rack, and the spring plate being firmly fixed together, and the rack having a plurality of evenly spacing side protrusions formed thereon.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic perspective view of the preferred embodiment of the multi-function utility knife of the invention.

FIG. 2a is a partial perspective view showing a right half thereof.

FIG. 2b is an enlarged view of the circle A shown in FIG. 2a. And

FIG. 3 is an exploded perspective view of the multi-function utility knife shown in FIG. 1.

### DETAILED DESCRIPTION OF THE INVENTION

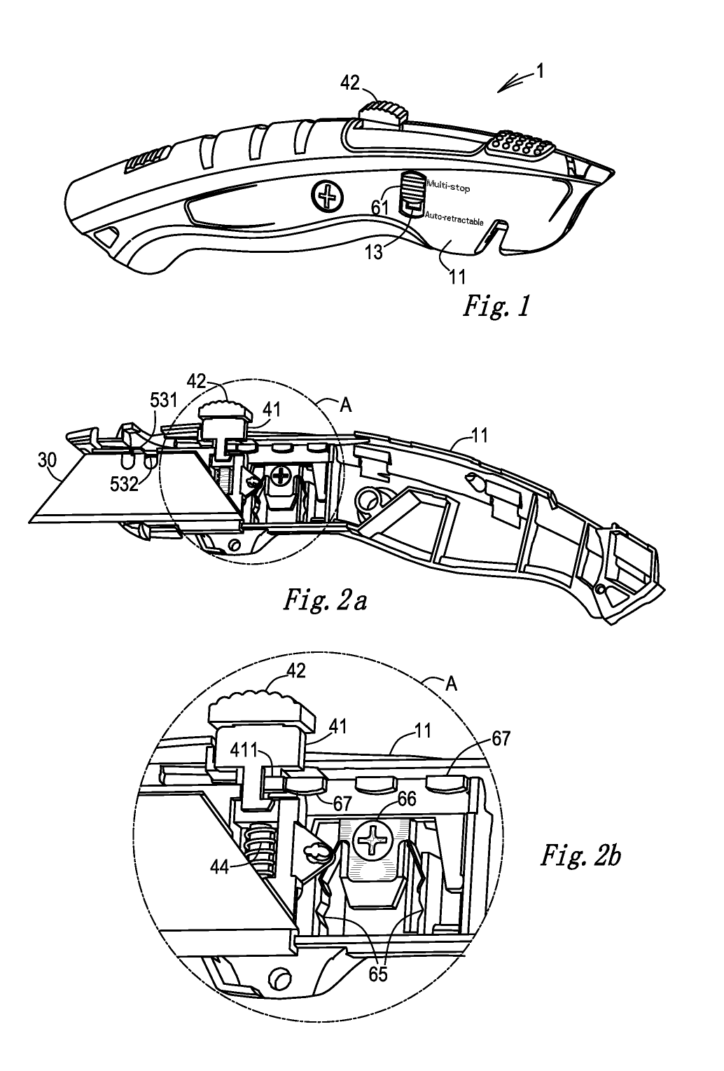

With reference to FIGS. 1, 2a, 2b, and 3, a multi-function utility knife 1 of the preferred embodiment of the invention is shown. The utility knife 1 has a housing 10, a blade seat 20 slidably received in the housing 10, a blade 30 fixed to the blade seat 20, a driving unit 40 for controlling the blade seat 20 to move forward, a blade seat return spring 21 one end thereof is fixed to the blade seat 20 and the other end thereof is fixed to an inner surface of the housing 10, a blade change means 50, and a function switch 60. The housing 10 is made up of a first side cover 11 and a second side cover 12 detachably coupling together. The housing 10 acts as both a handle and a container for the blade seat 20. The blade seat 20 has a blade seat, notch 22, and the blade 30 has at least one blade notch 31

The driving unit 40 has an actuator seat 41 reciprocally slidable in the housing 10, an actuator 42 being fixed to the actuator seat 41 and protruding out from the housing 10, a pole 43 securely formed on the actuator 42, and a restore spring 44 provided between the pole 43 and the blade seat 20. The pole 43 is being, inserted into the blade seat 20 and slidable upright with respect to the blade seat 20. As more particularly shown in FIG. 2b, a protrusion 411 facing outward from the utility knife 1 is formed on the actuator seat 41.

The blade change means 50 has a button 51, a resilient element 52 biasing the button 51 against the housing 10 and ensuring the button reciprocally moving between a depressed position and an un-depressed position, and a spring bar 53 having one end being fixed to the blade seat 20 and a free end having a side protruding pressing finger 531 and a blade installing finger 532. The blade installing finger 532 is in aliment with the blade seat notch 22. When the blade 30 is installed on the blade seat 20, the blade installing finger 532 passes through both the blade seat notch 22 and the blade notch 31, fixing the blade 30 with respect to the blade seat 20. Since the structure and function of the blade change means 50 is a conventional art, they will not be described herein in details.

The function switch 60 has a switching button 61 sticking out from the housing 10, a rack 62 contained in the housing 10, a spring plate 63 having at least one spring foot 64, and two positioning slots 65 in the inner surface of the housing 10 for receiving the spring foot 64 of the spring plate 63. The switching button 61, the rack 62, and the spring plate 63 are firmly fixed together. In this embodiment, they are fixed together with a screw 66. The switching button 61 is contained in a slit 13 defined in the housing 10 and being able to reciprocally move between a position of “Multi-stop” and another position of “Auto-retractable” on the housing 10. A plurality of evenly spacing side protrusions 67 are formed on the rack 62.

In a spare status of the multi-function utility knife 1, the blade seat 20 is pulled by the blade seat return spring 21 to a rear most retracted position. If a user wants to the blade 30 automatically retract back after cutting, he is able to move the switching button 61 downward to the “Auto-retractable” position. In this status, the rack 62 and the spring plate 63 fixed with the switching button 61 will move downward together at the same time. The spring foot 64 of the spring plate 63 will enter one relative lower positioning slot 65 and fix the switching button 61 with respect to the housing 10 at the position of “Auto-retractable” with a certain friction. At this, time, the side protrusions 67 on the rack 62 will just leave a route of the protrusion 411 on the actuator seat 41 to move forward and back. When the user release the actuator 42 after cutting, the blade seat 20, together with the blade 30 installed thereon, will be pulled back into the housing 10 by the blade seat return spring 21.

If the user wants the blade 30 to be multi-levelly locked in cutting, he is able to move the switching button 61 upward to the “Multi-stop” position. As shown in FIGS. 2a and 2b, in this status, the rack 62 and the spring plate 63 will move upward together at the same time The spring loot 64 of the spring plate 63 will enter one relative upper positioning slot 65 and fix the switching button 61 with respect to the housing 10 at the position of “Multi-stop” with a certain friction. At this time, the side protrusions 67 on the rack 62 will just enter the route of the protrusion 411 on the actuator seat 41 to move forward and back. The driving unit 40 is blocked by one of the side protrusions 67 and not able to move forward and back, and the blade 30 is thus being locked at a desirable length. When the user needs to adjust the length of the blade 30 extending out, he is able to press down the actuator 42 against the restore spring 44 and then push the actuator 42 forward or back. The protrusion 411 leaves the side protrusions 67 at this time and is able to move forward and back freely. When the user select a preferred extending length of the blade 30, he may release the pressure on the actuator 42 and the actuator 42 will move upward back under the restore spring 44. Another side protrusion 67 on the rack 62 will block the protrusion 411 on the blade seat 40 again. The blade 30 is locked at a new position.

When the user wants to change a new blade 30, he may press the button 51 against the resilient element 52. The button 51 pushes the pressing finger 531 away and the spring bar 53 leaves the blade seat 20. Thus, the installing finger 532 will leave the blade seat notch 22 and a blade notch 31. A used blade 30 will be able to be pulled out from the utility knife 1 and a new blade 30 will be able to be inserted. After the new blade 30 is inserted, the user is able to release the button 51, and the installing finger 532 re-enters the blade seat notch 22 and the blade notch 31. The new blade 30 is thus able to be securely installed.

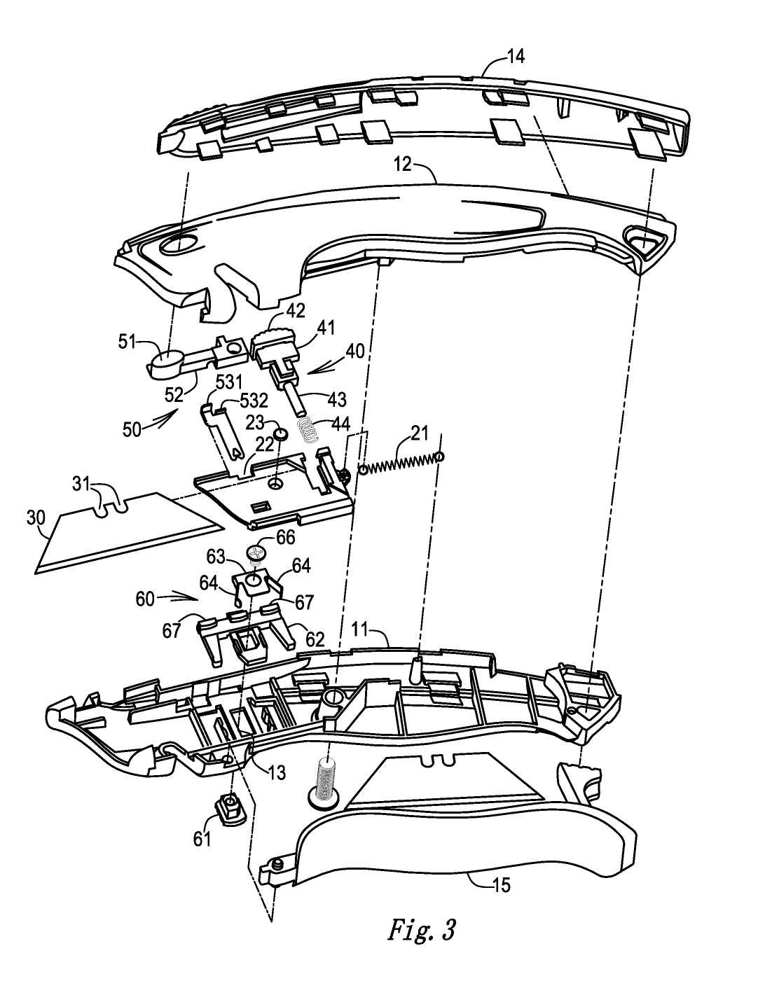

Back to FIG. 3, a magnet 23 may be fixedly installed on the blade seat 20 on a surface facing the blade 30. The magnet 23 is able to make the blade 30, which is ferrous, stabler with respect to the blade seat 20. An upper rubber housing cover 14 and a lower rubber housing cover 15 also may be provided to improve feeling of grasping of the utility knife 1. A rubber anti-slip pad 16 may be provided in front of the actuator 42.

From above description, it could be seen that a multi-function utility knife is realized through a simple structure. With one knife, a user will be able to select multi-levelly extension of the blade when he needs the blade to extend for a long time. When cuts a thin work piece, the user is able to extend the blade to a short length to avoid break of the blade. And when cuts a thick, object, the user is able to extend the blade long to cut the object through. When he needs to cut a small amount of soft work piece, he can select automatic retract to increase safety of the knife.

From above description, it is seen that the object of the present invention has been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A multi-function utility knife comprising:
a housing,
a blade seat slidably received in said housing and having a blade seat notch,
a blade fixed to said blade seat and having at least one blade notch,
a driving unit having an actuator seat reciprocally slidable along said housing, an actuator being fixed to said actuator seat and protruding out from said housing, a pole securely formed on said actuator seat, a restore spring provided between said pole and said blade seat, and a protrusion being formed on said actuator seat and facing outward from said housing,
a blade seat return spring having one end being fixed to said blade seat and the other end being fixed to an inner surface of said housing,
a blade change means having a button, a resilient element biasing said button against said housing, and a spring bar having one end being fixed to said blade seat and a free end having a side protruding pressing finger and a blade installing finger. and,
a function switch having a switching button, a rack contained in said housing, a spring plate, having at least one spring foot, and two positioning slots in said inner surface of said housing for receiving said spring foot of said spring plate, said switching button, said rack, and said spring plate being firmly fixed together, and said rack having a plurality of evenly spacing side protrusions formed thereon.

2. The multi-function utility knife as claimed in claim 1, wherein said housing is made up of a first side cover and a second side cover detachably coupling together.

3. The multi-function utility knife as claimed in claim 1, wherein a magnet is fixedly installed on said blade seat on a surface facing said blade.

4. The multi-function utility knife as claimed in claim 2, wherein a magnet is fixedly installed on said blade seat on a surface facing said blade.

5. The multi-function utility knife as claimed in claim 1, wherein said utility knife further has an upper rubber housing cover and a lower rubber housing cover.

6. The multi-function utility knife as claimed in claim 2, wherein said utility knife further has an upper rubber housing cover and a lower rubber housing cover.

7. The multi-function utility knife as claimed in claim 1, wherein said utility knife further has a rubber anti-slip pad in front of said actuator.

8. The multi-function utility knife as claimed in claim 2, wherein said utility knife further has a rubber anti-slip pad in front of said actuator.
